(19) United States
(12) Patent Application Publication
(10) Pub. No.: US 2019/0124115 A1
(43) Pub. Date: Apr. 25, 2019

(54) METHODS AND SYSTEM FOR MONITORING OF IOT DEVICES BASED ON ASSET VALUES

(71) Applicant: CyberRadar, Inc., Irvington, NY (US)

(72) Inventor: Raja Chris, Irvington, NY (US)

(21) Appl. No.: 16/122,706

(22) Filed: Sep. 5, 2018

Related U.S. Application Data
(60) Provisional application No. 62/575,860, filed on Oct. 23, 2017.

(51) Int. Cl. H04L 29/06; H04W 12/12; H04L 29/08

(52) U.S. Cl. CPC H04L 63/20; H04L 63/1441; H04L 67/22; H04W 12/12; H04L 63/1425

(57) ABSTRACT

A method for monitoring of IOT devices based on asset values is disclosed. The method may include receiving, using a communication device, monitoring data from a plurality of TOT devices. Further, the method may include retrieving, using a storage device, a plurality of asset values associated with the plurality of TOT devices. Further, the method may include retrieving, using the storage device, at least one behavioral policy associated with the plurality of TOT devices. Further, the method may include comparing, using a processing device, the monitoring data with the at least one behavioral policy. Further, the method may include identifying, using the processing device, at least one policy violation based on the comparing and the plurality of asset values. Further, the method may include transmitting, using the communication device, at least one notification to at least one user device based on identifying the at least one policy violation.

The current application claims a priority to the U.S. Provisional Patent application Ser. No. 62/575,860 filed on Oct. 23, 2017.

### FIELD OF THE INVENTION

The present disclosure generally relates to the field of information security. More specifically, the present disclosure relates to methods and systems for monitoring of IOT devices based on asset values.

### BACKGROUND OF THE INVENTION

In today's world, the concept of Internet of Things (IOT) has become very popular. Further, IOT in its most basic form can be characterized by products, devices, and/or items being connected online to each other and to humans. Accordingly, an IOT device may be capable of transferring data (e.g. sensor data) over a network such as the Internet and also receiving data (e.g. control commands).

While connectivity to the Internet brings several advantages, it also creates exposure to myriad security issues. In recent years there has been an exponential increase in the number of cyber-attacks. Such cyber-attacks are not limited to a virtual, non-physical context (e.g. a computer virus, malware); cyber-attacks can also occur in a physical context. Malevolent forces may hack into IOT devices such as smart TVs, refrigerators, microwave ovens, home alarm systems and even automobiles. Cyber-attacks can take out power grids and cause severe harm.

IOT devices are widely used in cyber security systems. Accordingly, IOT devices used in cyber security can continuously monitor databases, transactions, networks, servers, etc.

However, IOT devices currently employed for providing cyber security have a number of limitations. For example, IOT devices may send an overwhelming number of alerts to administrators (e.g. during a security breach), many of which may eventually be determined to be false-positives. However, in the interest of being safe rather than sorry, such alerts are generally allowed to be generated and processed, placing undue burden on users and/or administrators in managing cyber security. Further, while existing systems allow users to selectively view security status and/or receive alerts from a set of IOT devices, such selection is manual and tedious. Additionally, existing systems do not provide an intuitive visualization of security status of a large number of IOT devices. As a result, the ability of users to receive critical and relevant information regarding security violations that enable them to take corrective actions is hampered.

As such, there is a need for improved methods and systems for monitoring of IOT devices that may overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some aspects, a method for monitoring of IOT devices based on asset values is disclosed. The method may include receiving, using a communication device, monitoring data from a plurality of IOT devices. Further, the method may include retrieving, using a storage device, a plurality of asset values associated with the plurality of IOT devices. Further, the method may include retrieving, using the storage device, at least one behavioral policy associated with the plurality of IOT devices. Further, the method may include comparing, using a processing device, the monitoring data with the at least one behavioral policy. Further, the method may include identifying, using the processing device, at least one policy violation based on the comparing and the plurality of asset values. Further, the method may include transmitting, using the communication device, at least one notification to at least one user device. Further, the at least one notification may be based on identifying the at least one policy violation.

According to some aspects, a system for monitoring of IOT devices based on asset values is disclosed. The system may include a communication device configured for receiving monitoring data from a plurality of IOT devices. Further, the communication device may be configured for transmitting at least one notification to at least one user device. Further, the at least one notification may be based on identifying at least one policy violation. Further, the system may include a processing device configured for comparing the monitoring data with at least one behavioral policy. Further, the processing device may be configured for identifying the at least one policy violation based on the comparing and the plurality of asset values. Further, the system may include a storage device configured for retrieving a plurality of asset values associated with the plurality of IOT devices. Further, the storage device may be configured for retrieving the at least one behavioral policy associated with the plurality of IOT devices.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 illustrates a flowchart of a method for monitoring of IOT devices based on asset values, in accordance with some embodiments.

FIG. 3 illustrates a flowchart of a method for obtaining a plurality of asset values based on a plurality of asset attributes, in accordance with some embodiments.

FIG. 4 illustrates a flowchart of a method for acquiring at least one updated behavioral policy, in accordance with some embodiments.

FIG. 5 illustrates a flowchart of a method for obtaining an asset value indicator from a user device and accordingly identifying the plurality of IOT devices to be monitored for one or more policy violations, in accordance with some embodiments.

FIG. 6 illustrates a flowchart of a method for monitoring one or more policy violations corresponding to one or more IOT devices in an environment, in accordance with some embodiments.

FIG. 7 illustrates a flowchart of a method to filter security alerts from plurality of IOT devices based on the asset values and user hierarchy in the organization, in accordance with some embodiments.

FIG. 8 illustrates a flowchart of a method to facilitate the overriding of an IOT asset value based on past behavioral patterns, in accordance with some embodiments.

FIG. 9 illustrates a flowchart of a method to facilitate the user to procure priority alerts from a plurality of IOT devices installed in an airport, in accordance with some embodiments.

FIG. 10 illustrates a method to facilitate storing of asset values in an internal and/or external database, in accordance with some embodiments.

FIG. 11 illustrates a method to facilitate reporting of asset risk status in an asset database and dashboard, in accordance with some embodiments.

FIG. 12 illustrates a system to facilitate monitoring of IOT devices based on asset values, in accordance with some embodiments.

FIG. 13 is a flowchart of a method for depicting analysis performed by online platform based on a framework, in accordance with some embodiments.

FIG. 14 is a user interface of a mobile application that provides visual feedback associated with the security status of a plurality of IOT devices, in accordance with some embodiments.

FIG. 15 illustrates a user interface that provides a high-level view of the security status associated with plurality of IOT devices deployed within the environment, in accordance with some embodiments.

FIG. 16 is a block diagram of a system including computing device for implementing the methods disclosed herein, in accordance with some embodiments.

### DETAIL DESCRIPTIONS OF THE INVENTION

As a preliminary matter, it will readily be understood by anyone with skills in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here, the scope of which is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an industry professional would understand such term to mean based on the contextual use of the term. To the extent that the meaning of a term used herein—as understood by the industry professional based on the contextual use of such term—differs in any way from any particular dictionary definition of such term, it is intended that the meaning of the term as understood by the industry professional should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of monitoring of IOT devices based on asset values, embodiments of the present disclosure are not limited to use only in this context. For example, the disclosed techniques may be used for selectively presenting the security status of IOT devices based on an indication of the role of an individual.

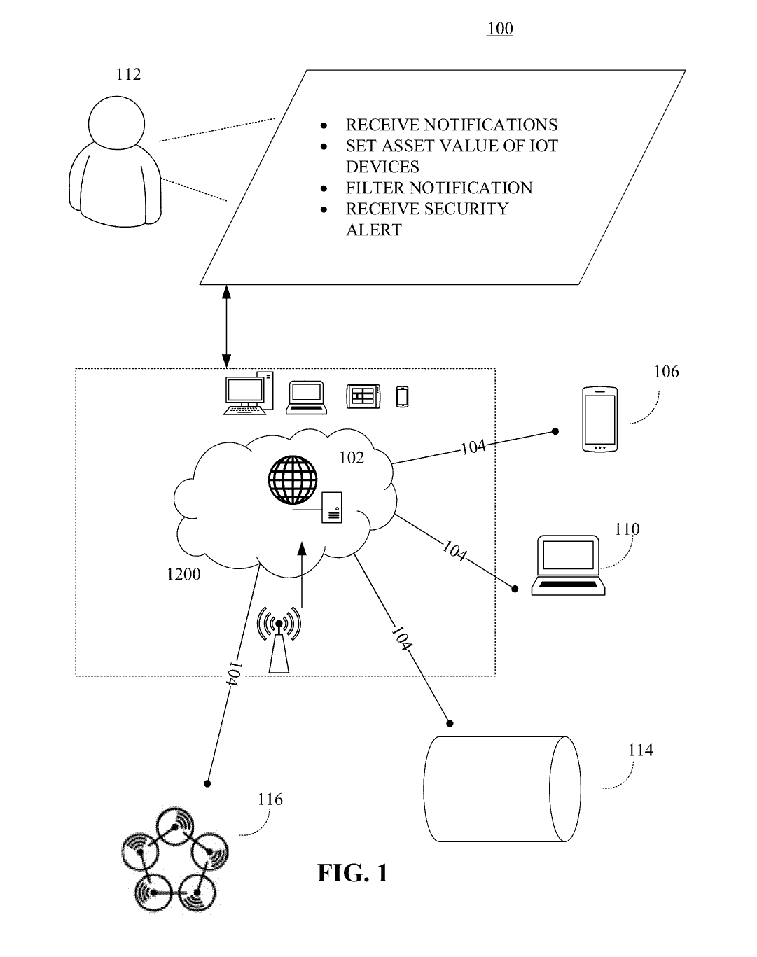

FIG. 1 is an illustration of a platform consistent with various embodiments of the present disclosure. By way of non-limiting example, the online platform 100 for monitoring of IOT devices based on asset values may be hosted on a centralized server 102, such as, for example, a cloud computing service. The centralized server 102 may communicate with other network entities, such as, for example, a mobile device 106 (a smartphone, a laptop, a tablet computer etc.), other electronic devices 110 (desktop computers, server computers etc.), external databases 114 (e.g. security policies database), and IOT devices 116, over a communication network 104, such as, but not limited to, the Internet. Further, users of the platform may include relevant parties such as security experts, system administrators, management personnel (e.g. CEOs, CTOs), et al. Accordingly, electronic devices operated by the one or more relevant parties may be in communication with the platform. For example, the mobile device 106 may be operated by a CTO of a bank who is conducting a security status check of IOT devices installed at ATMs associated with the bank.

A user 112, such as the one or more relevant parties, may access platform 100 through a web based software application or browser. The web based software application may be embodied, but not be limited to, a website, a web application, a desktop application, and a mobile application compatible with a computing device 600.

According to some embodiments, a method and a system (such as an online platform) are disclosed for monitoring of TOT devices based on asset values. Further, the asset value associated with an TOT device may represent a significance of the TOT device and/or an asset associated with the TOT device. For example, in case of an TOT device configured to monitor harmful environmental conditions (e.g. toxic gases, smoke, fire etc.), the asset value of the TOT device may be high as compared to another TOT device configured to monitor presence of occupants in a work space. As another example, an IOT device attached to a high priority asset (e.g. ATM kiosk or a bank locker) may be assigned a higher value as compared to an TOT device attached to a network printer.

Further, in some embodiments, the online platform may maintain a database of TOT devices deployed within an environment and their associated asset values. In an instance, an asset value of an TOT device may indicate a level of importance of the TOT device in terms of either the cost involved in procuring and operating the TOT device and/or the criticality of the TOT device.

Further, in some embodiments, the online platform may be configured to communicate, using a communication device, with external databases, such as, for example, a policy database. In an instance, the policy database may be configured to store policies associated with the functioning of TOT devices such as those associated with security violations, operational malfunctions etc.

Further, according to some embodiments, the online platform may be configured to communicate, using the communication device, with TOT devices installed at a particular location. An online platform may allow a user to view security status corresponding to TOT devices and notifications and/or alerts sent by the TOT devices installed at an area, such as, for example, a hospital. Another example would be the TOT device that sends an alert to a bank professional (e.g. a bank manager) whenever someone who is not a part of the bank staff accesses a safe deposit bank locker.

According to an embodiment, the online platform may perform filtering of notifications transmitted by the TOT devices and/or selective generation of notifications based on data transmitted by the TOT devices. Further, the notifications may be generated based on a policy violation. Accordingly, the filtering of notifications associated with the IOT devices may prevent the IOT devices from sending multiple notifications to users. In an ideal scenario, the online platform may filter notifications based upon asset value associated with the IOT devices. Therefore, the online platform may be configured to send notifications (e.g. high value alerts) corresponding to, for example, only high value assets. In an instance, the high value alerts may be called red alerts. Further, the high value alerts may either be based on a high value of an IOT device, high level of risk and/or a security breach, and/or a high value of the asset associated with the IOT device.

Further, in an embodiment, the IOT devices may be configured to selectively alert the users based on corresponding asset values. For example, among IOT devices installed at a bank, only the IOT devices which are associated with bank lockers may send an alert and/or a security status report since these IOT devices may be the most critical in terms of monetary value.

Further, in an embodiment, an asset value based notification system may also allow a user to view security status of the IOT devices that are most critical in terms of the asset value associated with the corresponding IOT device. Accordingly, the online platform may provide a user interface (e.g. a GUI) that provides a high level view of security status associated with a larger number of IOT devices deployed within an environment (e.g. home, office, factory, city, state, etc.). Accordingly, a plant manager may access the online platform and view security status and/or security reports associated with only the TOT devices installed at a boiler area of the power plant.

According to some embodiments, the method may include a step of receiving, using the communication device, monitoring data from a plurality of TOT devices. The monitoring data may include operational data and/or security status data associated with an TOT device.

Further, in an embodiment, the plurality of TOT devices may transmit operational data and/or security status data. In another embodiment, the operational data and/or the security status data may be sent by a secondary TOT device installed in the vicinity of a primary TOT device. Accordingly, the secondary TOT device may fetch the monitoring data from the primary TOT device, and then transmit the monitoring-data to the online platform.

Further, the method may include a step of retrieving, using a storage device, a plurality of behavioral policies associated with the plurality of IOT devices. In an instance, the online platform may query internal and/or external databases in order to retrieve the behavioral policies associated with the plurality of IOT devices. The behavioral policies may represent policies and/or guidelines associated with the functioning, data-capturing, and notifying associated with the plurality of IOT devices. In an instance, the online platform may also retrieve security policies associated with the plurality of IOT devices.

Further, the method may include a step of identifying, using a processing device, one or more policy violations based on a comparison of the monitoring-data with the corresponding behavioral policies and associated plurality of asset values associated with the plurality of IOT devices. The asset value associated with the plurality of IOT devices may be a significant factor during the evaluation.

Further, the method may include a step of generating, using a processing device, a heat map depicting the one or more policy violations in association with the corresponding plurality of IOT devices. Further, the heat map includes indication of policy violations of IOT devices associated with a predetermined value (or range of values). In an instance, the GUI associated with the online platform may display a heat map based upon the one or more policy violations in association with the corresponding plurality of IOT devices. Further, the heat map may follow a specific color coding as determined by the online platform. Accordingly, the heat map may represent areas having IOT devices as low risk, high risk, and medium risk.

Further, in some embodiments, the online platform may provide a feature of selectively checking for policy violations. Accordingly, the method may first include a step of receiving, using the communication device, the monitoring-data from a plurality of IOT devices. Thereafter, the online platform may retrieve, using the storage device, a plurality of asset values associated with the plurality of IOT devices. Further, the method may include a step of identifying, using the processing device, a selected set of IOT devices based on a predetermined threshold value (e.g. specified by an admin). For example, a plant manager may select a set of the IOT devices installed at a factory and send the selection to the online platform. In an instance, the plant manager may only be concerned about the IOT devices which are most critical in terms of cost, operation, and placement (i.e. location where the IOT device is installed). Accordingly, the online platform may associate a high value corresponding to the TOT devices selected by the plant manager. Further, the method may include a step of retrieving, using the storage device, a plurality of behavioral policies (e.g. security violation policies) associated with the selected set of TOT devices. Thereafter, the method may include a step of identifying, using the processing device, one or more policy violations based on comparison of monitoring-data associated with the selected set of TOT devices and the plurality of behavioral policies. For example, the online platform may identify whether a security risk associated with an TOT device is categorized as a low risk, medium risk, or a high risk. Further, the method may include a step of transmitting, using the communication device, a notification to one or more interested parties based on identifying the one or more policy violations.

The online platform may send alerts to the user according to the role assigned to that user. The online platform may query a database that stores the roles associated with each employee of an organization and then the online platform may accordingly alert users based upon their role. Additionally, a heat map can also be generated based on the policy violation(s) identified. The heat map displayed to a user may be based upon the role of the user. In an ideal scenario, the online platform may determine a selection of IOT devices based upon the role and associated value of the plurality of TOT devices. Further, the online platform may generate and display the heat map for selected TOT devices as determined by the online platform.

According to some embodiments, the online platform may also include a feature of automatically generating and/or updating a database of values corresponding to TOT devices based on one or more factors. For instance, the online platform may generate and update an asset value associated with the plurality of TOT devices based upon their individual significance. This asset value may be based upon factors such as cost, impact on other TOT devices and/or the network, its history of problem/solution logs or reports, etc.

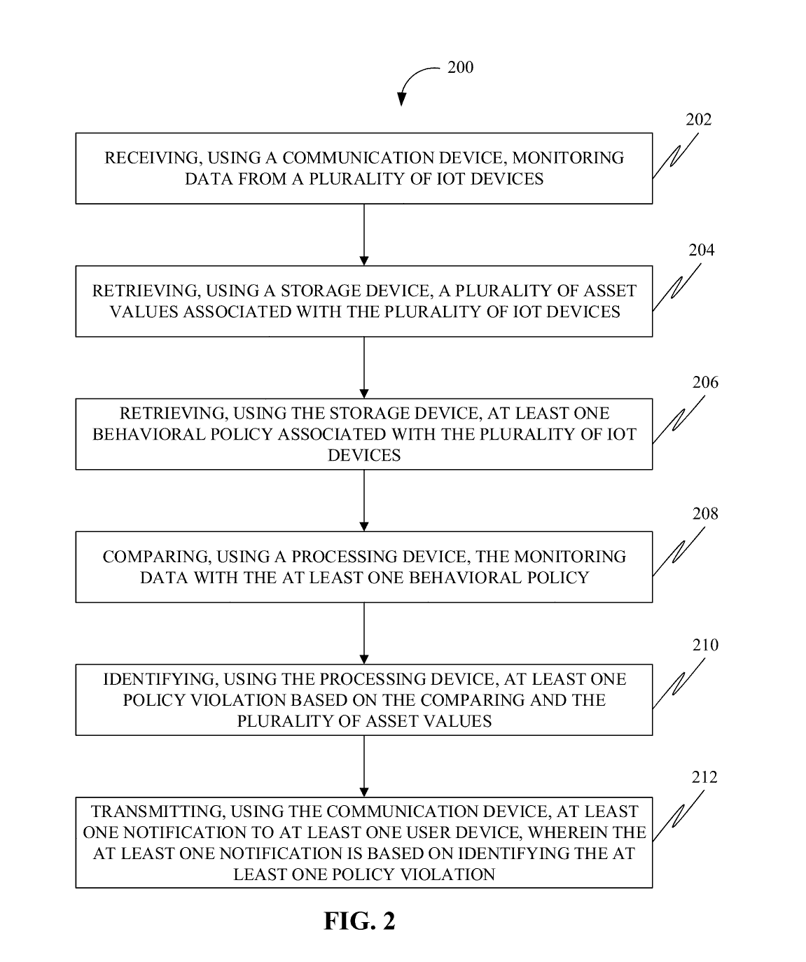

FIG. 2 illustrates a flowchart of a method 200 for monitoring of TOT devices based on asset values, in accordance with some embodiments. The method 200 may include a step 202 of receiving, using a communication device, monitoring data from a plurality of IOT devices. In some embodiments, an IOT device may include at least one sensor configured to detect at least one variable associated with an environment and a wireless transmitter communicatively coupled to the at least one sensor. Further, the wireless transmitter may be configured for wirelessly transmitting monitoring data from the at least one sensor to a server computer. Moreover, the at least one sensor may include at least one external sensor configured to detect at least one external variable associated with an external environment and at least one internal sensor configured to detect at least one internal variable associated with an internal environment. In an instance, the external environment may include a region of interest and/or one or more objects in the region of interest. For example, the external environment associated with an IOT device such as a camera based motion detector may include a physical space captured within the field of view of the camera and/or one or more objects that may be temporarily and/or permanently be present within the physical space. In an instance, the internal environment may include an interior region of the IOT device and/or a region of immediacy surrounding the IOT device. In an instance, the internal environment may have a bearing on an operation of the IOT device. Accordingly, in an instance, monitoring of the internal environment by the at least one internal sensor may provide monitoring data associated with an operational state of the IOT device.

Further, the method 200 may include a step 204 of retrieving, using a storage device, a plurality of asset values associated with the plurality of IOT devices. In some embodiments, an asset value of the plurality of asset values associated with an IOT device of the plurality of IOT devices may be based on a significance of one or more of the IOT device and an asset associated with the IOT device.

In general, the asset value may be based on one or more attributes of one or more operations associated with the IOT device such as, but not limited to, manufacturing, assembling, transporting, handling, installing, deploying, maintaining, operating, repairing, recycling, and so on. Further, the one or more attributes may include, but is not limited to, one or more of time, cost, human effort, and so on.

In an instance, an asset value based on the asset may be based on one or more attributes of one or more operations associated with the asset such as, but not limited to, manufacturing, assembling, transporting, handling, installing, deploying, maintaining, operating, repairing, recycling, and so on. Further, the one or more characteristics may include, but is not limited to, one or more of time, cost, human effort, and so on.

In an instance, the asset value based on the asset may be based a plurality of asset attributes and corresponding plurality of asset attribute values. Further, the plurality of asset attributes may be associated with a plurality of weights. Accordingly, in an instance, the asset value may be based on a weighted combination of the plurality of asset attribute values.

Further, the method 200 may include a step 206 of retrieving, using the storage device, at least one behavioral policy associated with the plurality of IOT devices. In general, a behavioral policy may include a specification of at least one of a normal behavior and an abnormal behavior. Further, in an instance, the specification may include at least one parameter associated with a behavior and at least one value corresponding to the at least one parameter. In other words, a behavior may be specified in terms of one or more parameters and corresponding one or more values. Further, in an instance, the behavior may be specified in terms of a plurality of values corresponding to a parameter. For example, the normal behavior associated with the behavioral policy may be specified by a range of normal values associated with the parameter. Similarly, the abnormal behavior associated with the behavioral policy may be specified by a range of abnormal values.

In an instance, a plurality of behavioral policies may include one or more of an internal behavioral policy and an external behavioral policy. The internal behavioral policy may be associated with an internal environment of an IOT device of the plurality of IOT devices. Further, the external behavioral policy may be associated with an external environment of the TOT device.

In some embodiments, the at least one behavioral policy may include a plurality of behavioral policies. Further, the plurality of behavioral policies may be associated with a plurality of risk levels. In general, a risk level associated with a behavioral policy may be based on an importance of the behavioral policy with regard to overall operation of the corresponding TOT device. In other words, the TOT device may be configured to exhibit multiple behaviors, a first behavior of which may be relatively more important than a second behavior. Accordingly, a first behavioral policy associated with the first behavior may be associated with a higher risk level than a second behavioral policy associated with the second behavior. Accordingly, in some embodiments, an order of comparing the monitoring data with the plurality of behavioral policies may be based on the plurality of risk levels. For example, the monitoring data may be compared with a first behavioral policy associated with a high risk level. Subsequently, the monitoring data may be compared with a second behavioral policy associated with a medium risk level. Thereafter, the monitoring data may be compared with a third behavioral policy associated with a low risk level. As a result, a policy violation associated with a relatively higher risk status may be detected early on and notified.

Further, the method 200 may include a step 208 of comparing, using a processing device, the monitoring data with the at least one behavioral policy. For instance, actual values of a set of parameters associated with an IOT device of the plurality of IOT devices may be compared with corresponding set of values associated with the set of parameters corresponding to a behavioral policy.

Further, the method 200 may include a step 210 of identifying, using the processing device, at least one policy violation based on the comparing and the plurality of asset values. For instance, when the actual values of the set of parameters is significantly different from the corresponding set of values associated with the set of parameters as defined in the behavioral policy, and when an asset value of the IOT device is greater than a predetermined threshold asset value, a policy violation may be identified. In other words, in some embodiments, identifying the at least one policy violation may be based on each of the plurality of asset values meeting an asset value criterion (e.g. the predetermined threshold asset value) and the monitoring data being non-compliant with the at least one behavioral policy.

Further, the method 200 may include a step 212 of transmitting, using the communication device, at least one notification to at least one user device. Further, the at least one notification may be based on identifying the at least one policy violation. In some embodiments, the at least one notification may include a heat map depicting the at least one policy violation. Further, the method further may include generating, using the processing device, the heat map.

In some embodiments, an IOT device of the plurality of IOT devices may include a first IOT device and a second IOT device. Further, the monitoring data may include security status data associated with the first IOT device and operational data associated with the first IOT device. Further, the first IOT device may be configured to generate the security status data. Further, the second IOT device may be configured to generate the operational data associated with the first IOT device. Accordingly, in an embodiment, the second IOT device may be configured to monitor operation of the first IOT device. As a result, the monitoring data may be captured and/or transmitted even in case the first IOT device is partially and/or completely in-operational and/or mal-functional.

In some embodiments, the method may further include receiving, using the communication device, a role indicator from a user device of the at least one user device. Further, the role indicator represents a role of a user associated with the user device. Further, the identifying of the at least one policy violation may be further based on the role.

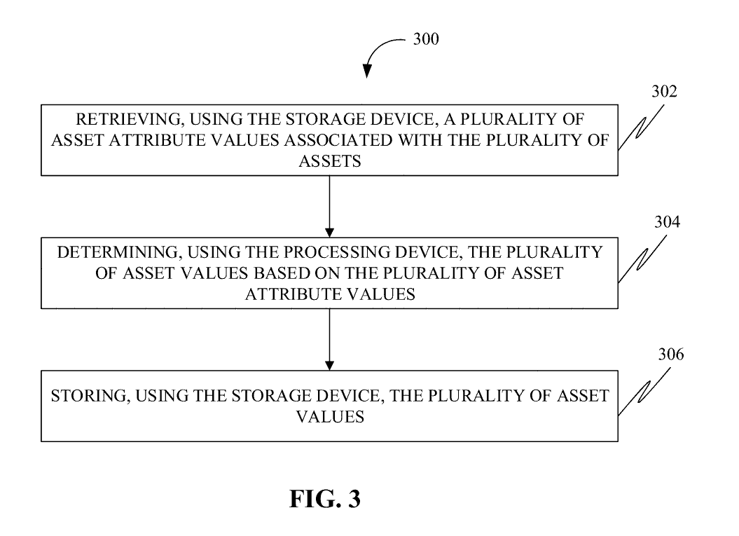

FIG. 3 illustrates a flowchart of a method 300 for obtaining a plurality of asset values based on a plurality of asset attributes, in accordance with some embodiments. The method 300 may include a step 302 of retrieving, using the storage device, a plurality of asset attribute values associated with the plurality of assets. Further, the method 300 may include a step 304 of determining, using the processing device, the plurality of asset values based on the plurality of asset attribute values. Further, the method 300 may include a step 306 of storing, using the storage device, the plurality of asset values.

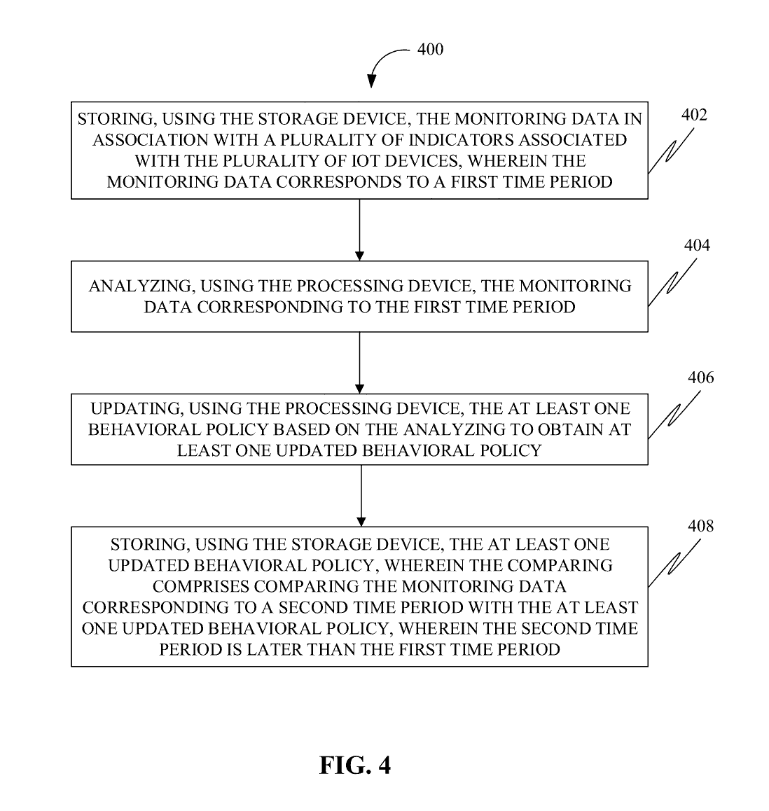

FIG. 4 illustrates a flowchart of a method 400 for acquiring at least one updated behavioral policy, in accordance with some embodiments. The method 400 may include a step 402 of storing, using the storage device, the monitoring data in association with a plurality of indicators associated with the plurality of IOT devices, wherein the monitoring data corresponds to a first time period. Further, the method 400 may include a step 404 of analyzing, using the processing device, the monitoring data corresponding to the first time period. Further, the method 400 may include a step 406 of updating, using the processing device, the at least one behavioral policy based on the analyzing to obtain at least one updated behavioral policy. Further, the method 400 may include a step 408 of storing, using the storage device, the at least one updated behavioral policy, wherein the comparing comprises comparing the monitoring data corresponding to a second time period with the at least one updated behavioral policy, wherein the second time period is later than the first time period.

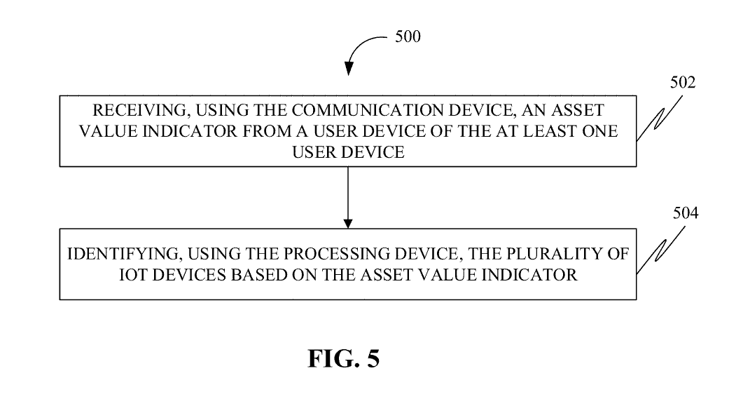

FIG. 5 illustrates a flowchart of a method 500 for obtaining an asset value indicator from a user device and accordingly identifying the plurality of IOT devices to be monitored for one or more policy violations, in accordance with some embodiments. The method 500 may include a step 502 of receiving, using the communication device, an asset value indicator from a user device of the at least one user device. In general, the asset value indicator may specify the plurality of IOT devices in terms of one or more corresponding asset values. For example, the asset value indicator may include a range of asset values, a single asset value, a threshold asset value and so on. For example, by specifying a threshold asset value, a security administrator may select those IOT devices whose asset values is greater than or equal to the threshold asset value. Accordingly, the security administrator is enabled to focus security related tasks on IOT devices corresponding to a chosen asset value (or a range thereof). Further, the method 500 may include a step 504 of identifying, using the processing device, the plurality of IOT devices based on the asset value indicator.

A system (such as, for example, the computing device 1600 and/or the online platform) for monitoring of IOT devices based on asset values is also disclosed. The system may include a communication device configured for receiving monitoring data from a plurality of IOT devices. In some embodiments, an IOT device may include at least one sensor configured to detect at least one variable associated with an environment and a wireless transmitter communicatively coupled to the at least one sensor. Further, the wireless transmitter may be configured for wirelessly transmitting monitoring data from the at least one sensor to a server computer. The at least one sensor may include at least one external sensor configured to detect at least one external variable associated with an external environment and at least one internal sensor configured to detect at least one internal variable associated with an internal environment. In an instance, the external environment may include a region of interest and/or one or more objects in the region of interest. For example, the external environment associated with an IOT device such as a camera based motion detector may include a physical space captured within the field of view of the camera and/or one or more objects that may be temporarily and/or permanently be present within the physical space. In an instance, the internal environment may include an interior region of the IOT device and/or a region of immediacy surrounding the IOT device. In an instance, the internal environment may have a bearing on an operation of the IOT device. Accordingly, in an instance, monitoring of the internal environment by the at least one internal sensor may provide monitoring data associated with an operational state of the IOT device.

Further, the communication device may be configured for transmitting at least one notification to at least one user device. Further, the at least one notification may be based on identifying at least one policy violation. In some embodiments, the at least one notification may include a heat map depicting the at least one policy violation. Further, the processing device may be further configured for generating the heat map.

Further, the system may include a processing device configured for comparing the monitoring data with at least one behavioral policy. The processing device may include, for example, processing unit 1602. In general, a behavioral policy may include a specification of at least one of a normal behavior and an abnormal behavior. Further, in an instance, the specification may include at least one parameter associated with a behavior and at least one value corresponding to the at least one parameter. In other words, a behavior may be specified in terms of one or more parameters and corresponding one or more values. Further, in an instance, the behavior may be specified in terms of a plurality of values corresponding to a parameter. For example, the normal behavior associated with the behavioral policy may be specified by a range of normal values associated with the parameter. Similarly, the abnormal behavior associated with the behavioral policy may be specified by a range of abnormal values.

In an instance, the plurality of behavioral policies may include one or more of an internal behavioral policy and an external behavioral policy. The internal behavioral policy may be associated with an internal environment of an IOT device of the plurality of IOT devices. Further, the external behavioral policy may be associated with an external environment of the IOT device.

Further, the processing device may be configured for identifying the at least one policy violation based on the comparing and the plurality of asset values. In some embodiments, an asset value of the plurality of asset values associated with an IOT device of the plurality of IOT devices may be based on a significance of one or more of the IOT device and an asset associated with the IOT device. In general, an IOT device value may be based on one or more attributes of one or more operations associated with the IOT device such as, but not limited to, manufacturing, assembling, transporting, handling, installing, deploying, maintaining, operating, repairing, recycling, and so on. Further, the one or more attributes may include, but is not limited to, one or more of time, cost, human effort, and so on.

In an instance, an asset value based on the asset may be based on one or more attributes of one or more operations associated with the asset such as, but not limited to, manufacturing, assembling, transporting, handling, installing, deploying, maintaining, operating, repairing, recycling, and so on. Further, the one or more characteristics may include, but is not limited to, one or more of time, cost, human effort, and so on.

In an instance, the asset value based on the asset may be based a plurality of asset attributes and corresponding plurality of asset attribute values. Further, the plurality of asset attributes may be associated with a plurality of weights. Accordingly, in an instance, the asset value may be based on a weighted combination of the plurality of asset attribute values.

In some embodiments, the storage device may be further configured for retrieving a plurality of asset attribute values associated with the plurality of assets; and storing the plurality of asset values. Further, the processing device may be further configured for determining the plurality of asset values based on the plurality of asset attribute values.

Further, the system may include a storage device configured for retrieving a plurality of asset values associated with the plurality of IOT devices. Further, the storage device may be configured for retrieving the at least one behavioral policy associated with the plurality of IOT devices. The storage device may include, for example, one or more of removable storage 1609 and non-removable storage 1610.

In some embodiments, the at least one behavioral policy may include a plurality of behavioral policies. Further, a plurality of behavioral policies may be associated with a plurality of risk levels. In general, a risk level associated with a behavioral policy may be based on an importance of the behavioral policy with regard to overall operation of the corresponding IOT device. In other words, the IOT device may be configured to exhibit multiple behaviors, a first behavior of which may be relatively more important than a second behavior. Accordingly, a first behavioral policy associated with the first behavior may be associated with a higher risk level than a second behavioral policy associated with the second behavior. Accordingly, in some embodiments, an order of comparing the monitoring data with the plurality of behavioral policies may be based on the plurality of risk levels. For example, the monitoring data may be compared with a first behavioral policy associated with a high risk level. Subsequently, the monitoring data may be compared with a second behavioral policy associated with a medium risk level. Thereafter, the monitoring data may be compared with a third behavioral policy associated with a low risk level. As a result, a policy violation associated with a relatively higher risk status may be detected early on and notified.

In some embodiments, an IOT device of the plurality of IOT devices may include a first IOT device and a second IOT device. Further, the monitoring data may include security status data associated with the first IOT device and operational data associated with the first IOT device. Further, the first IOT device may be configured to generate the security status data. Further, the second IOT device may be configured to generate the operational data associated with the first IOT device. Accordingly, in an embodiment, the second IOT device may be configured to monitor operation of the first IOT device. As a result, the monitoring data may be captured and/or transmitted even in case the first IOT device is partially and/or completely in-operational and/or mal-functional.

In some embodiments, the communication device may be further configured for receiving a role indicator from a user device of the at least one user device. Further, the role indicator represents a role of a user associated with the user device. Further, the identifying of the at least one policy violation may be further based on the role.

In some embodiments, the storage device may be further configured for storing the monitoring data in association with a plurality of indicators associated with the plurality of TOT devices. Further, the monitoring data corresponds to a first time period; storing, using the storage device, at least one updated behavioral policy. Further, the comparing may include comparing the monitoring data corresponding to a second time period with at least one updated behavioral policy. Further, the second time period may be later than the first time period. Further, the processing device may be further configured for analyzing the monitoring data corresponding to the first time period; and updating the at least one behavioral policy based on the analyzing to obtain the at least one updated behavioral policy.

In some embodiments, the communication device may be further configured for receiving an asset value indicator from a user device of the at least one user device. Further, the processing device may be further configured for identifying the plurality of IOT devices based on the asset value indicator. In general, the asset value indicator may specify the plurality of IOT devices in terms of one or more corresponding asset values. For example, the asset value indicator may include a range of asset values, a single asset value, a threshold asset value and so on. For example, by specifying a threshold asset value, a security administrator may select those IOT devices whose asset values is greater than or equal to the threshold asset value. Accordingly, the security administrator is enabled to focus security related tasks on IOT devices corresponding to a chosen asset value (or a range thereof).

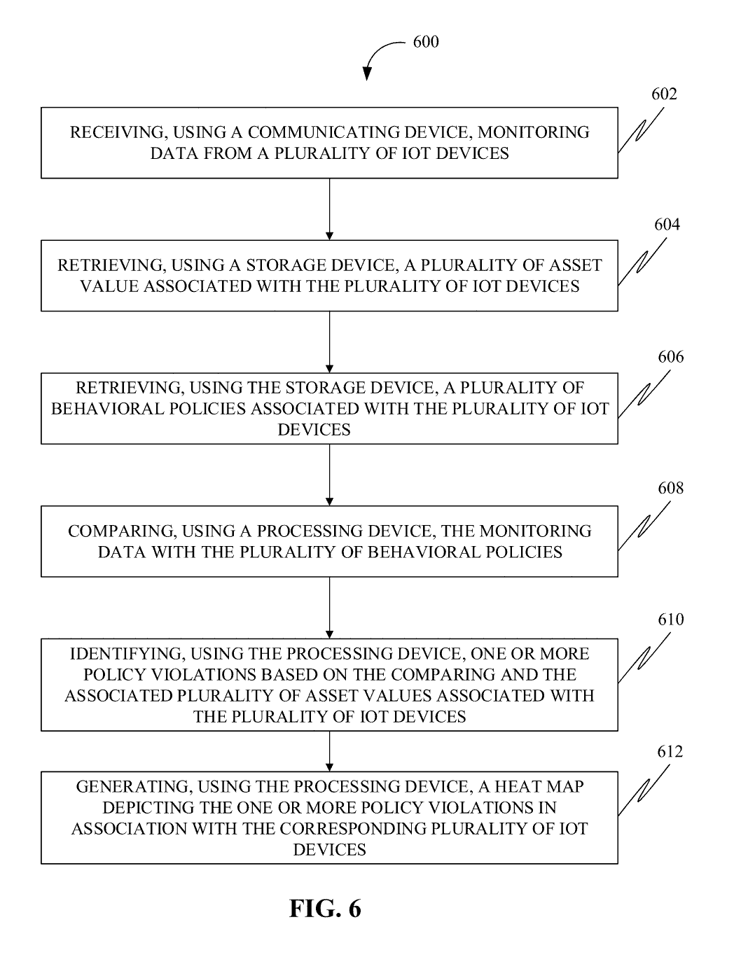

FIG. 6 illustrates a flowchart of a method 600 for monitoring one or more policy violations corresponding to one or more IOT devices in an environment, in accordance with some embodiments. The method 600 may include a step 602 of receiving, using the communication device, monitoring data from a plurality of IOT devices. The monitoring data may include operational data and/or security data associated with the IOT devices. In an instance, the IOT device attached to a surveillance camera may include monitoring data involve a video feed which may be used to detect a security breach in the vicinity of the surveillance camera.

Further, in an embodiment, the plurality of IOT devices may transmit operational data and/or security status data. In another embodiment, the operational data and/or the security status data may be sent by a secondary IOT device installed in the vicinity of a primary IOT device. Accordingly, the secondary IOT device may fetch the monitoring data from the primary IOT device, and then transmit the monitoring-data to the online platform.

Further, the method 600 may include a step 604 of retrieving, using a storage device, a plurality of asset values associated with the plurality of IOT devices. The asset value associated with an IOT device may represent a significance of the IOT device. In an instance, in case of an IOT device configured to monitor harmful environmental conditions (e.g. toxic gases, smoke, fire etc.), the asset value of the IOT device may be high as compared to another IOT device configured to monitor presence of occupants in a work space. In another instance, an IOT device attached to a high priority asset (e.g. ATM kiosk or a bank locker) may be assigned a higher value as compared to an IOT device attached to a network printer.

The online platform may retrieve the plurality of asset values corresponding to plurality of IOT devices by querying with the internal and/or external database. In an embodiment, the plurality of asset values may also be retrieved from a cloud storage platform such as Dropbox®.

Further, in an embodiment, the asset value may also depend on various factors, such as, cost, impact on other IOT devices and/or network, history of problem/solution logs or reports, etc. Accordingly, the asset value of an IOT device configured to detect presence of harmful gases in the environment may have a high asset value compared to another IOT device configured to measure the temperature of the work space.

In another embodiment, the asset value may be different for same IOT devices placed in different areas. In an instance, the asset value of an IOT device installed in the security surveillance department configured to detect intrusion of a person in the territory may have a higher asset value compared to another IOT device installed in the work space to monitor the presence of occupants.

Further, the method 600 may include a step 606 of retrieving, using a storage device, a plurality of behavioral policies associated with the plurality of IOT devices. Accordingly, the online platform may query internal and/or external databases in order to retrieve the behavioral policies associated with the plurality of IOT devices. The behavioral policies may represent policies and/or guidelines associated with the functioning, data-capturing, and notifying associated with the plurality of IOT devices. In an instance, the online platform may also retrieve security policies associated with the plurality of IOT devices. In an instance, the online platform may query internal and/or external databases associated with the IOT devices attached to the surveillance camera to retrieve behavioral and/or security policies associated with the IOT device.

Further, the method 600 may include a step 608 of comparing, using a processing device, the monitoring data with the plurality of behavioral policies. In an instance, the behavioral polices may include conditions corresponding to security violations associated with the IOT devices. The online platform may compare the monitored-data with the behavioral policy stored in an internal and/or external database.

Further, in an embodiment, the monitored data may be compared with the previous monitored data stored in the internal and/or external database corresponding to a specific IOT device. In an instance, the monitored data associated with the high risk asset (such as an ATM kiosk or a bank locker) may be compared to find the change from the monitored data from previous week or month. The change may further be compared with the behavioral policy.

Further, the method 600 may include a step 610 of identifying, using the processing device, one or more policy violations based on the comparing and associated plurality of asset values associated with the plurality of IOT devices. Accordingly, based on the comparing of plurality of IOT devices with the behavioral policies, the one or more policy violations may be identified.

Further, in one embodiment, the one or more violation may correspond to the irregular behavior of the IOT device. In another embodiment, the asset value may be a significant factor during the identifying. Accordingly, the one or more violations may be filtered based on the asset value of the IOT device. Further, the one or more policy violation corresponding to the high asset value of the IOT device may be considered a high risk, whereas medium and low risks may be associated with medium and low asset values of the IOT devices.

Further, the method 600 may include a step 612 of generating, using the processing device, a heat map depicting the one or more policy violations in association with the corresponding plurality of IOT devices. Further, the heat map includes indication of policy violations of TOT devices associated with a predetermined value (or range of values). In an instance, the GUI associated with the online platform may display a heat map based upon the one or more policy violations in association with the corresponding plurality of TOT devices. Further, the heat map may follow a specific color coding as determined by the online platform. In an instance, the high policy violation IOT device may be considered a high-risk IOT device.

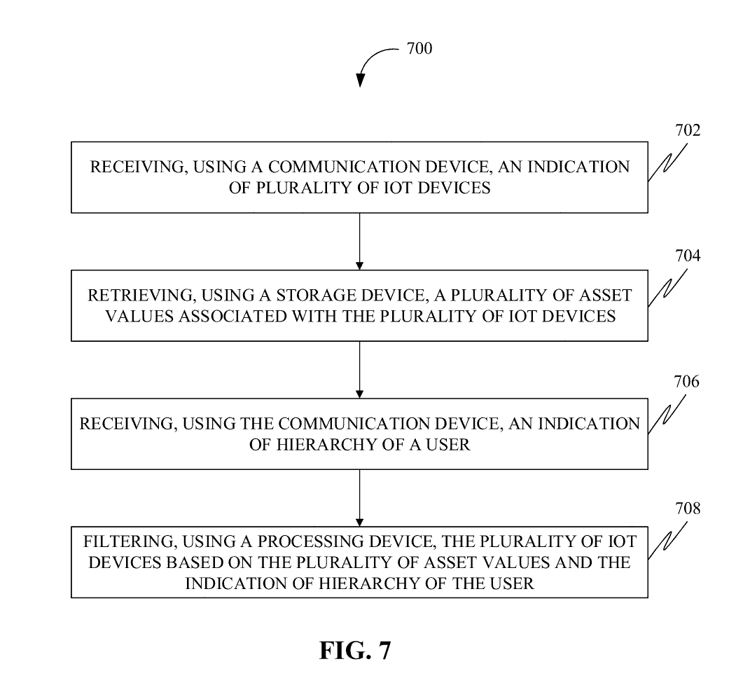

FIG. 7 illustrates a flowchart of a method 700 to filter security alerts from plurality of IOT devices based on the asset value and user hierarchy in the organization, in accordance with some embodiments. The method 700 may include a step 702 of receiving, using a communication device, an indication of plurality of IOT devices. The indication of plurality of IOT devices may include the list of IOT devices installed in the organization. The organization may be a work space or a government organization. In an instance, the organization may have an IOT device to monitor the presence of occupants in the work space.

In an embodiment, the online platform may receive the indication of plurality of IOT devices by querying internal and/or external databases. In another embodiment, the online platform may receive the indication of plurality of IOT devices from another IOT device which houses the details of IOT devices installed in the work space.

Further, the method 700 may include a step 704 of retrieving, using a storage device, a plurality of asset values associated with the plurality of IOT devices. The asset value associated with an IOT device may represent a significance of the IOT device.

In an instance, the asset value associated with an IOT device to monitor fire alarm warning may have a high asset value compared to the asset value of an IOT device used for monitoring the temperature of the work space.

Further, the method 700 may include a step 706 of receiving, using the communication device, a hierarchy of a user. The hierarchy of the user may be the role of the user in the organization. For example, the user of the online platform may be a manager of the organization.

Further, the method 700 may include a step 708 of filtering, using a processing device, the plurality of IOT devices based on the plurality of asset values and the hierarchy of the user. The plurality of the IOT devices may be filtered based on the asset value and the hierarchy of the user and security alert from high priority IOT devices may be displayed. For example, if the user of the online platform if the floor supervisor of the factory, then the user interface of the mobile application may only display security status associated with IOT devices installed at the production floor and/or the machine shop.

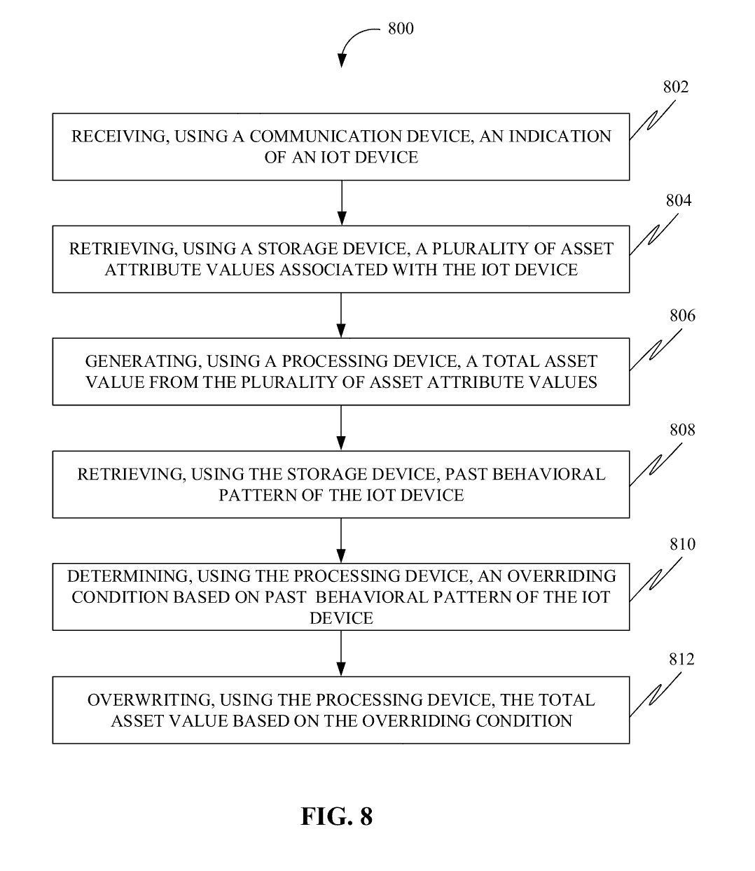

FIG. 8 illustrates a flowchart of method 800 to facilitate the overriding of an IOT asset value based on past behavioral patterns, in accordance with some embodiments. The method 800 may include a step 802 of receiving, using a communication device, an indication of an IOT device. The indication of plurality of IOT devices may include the list of IOT devices installed in the organization. The organization may be a work space or a government organization.

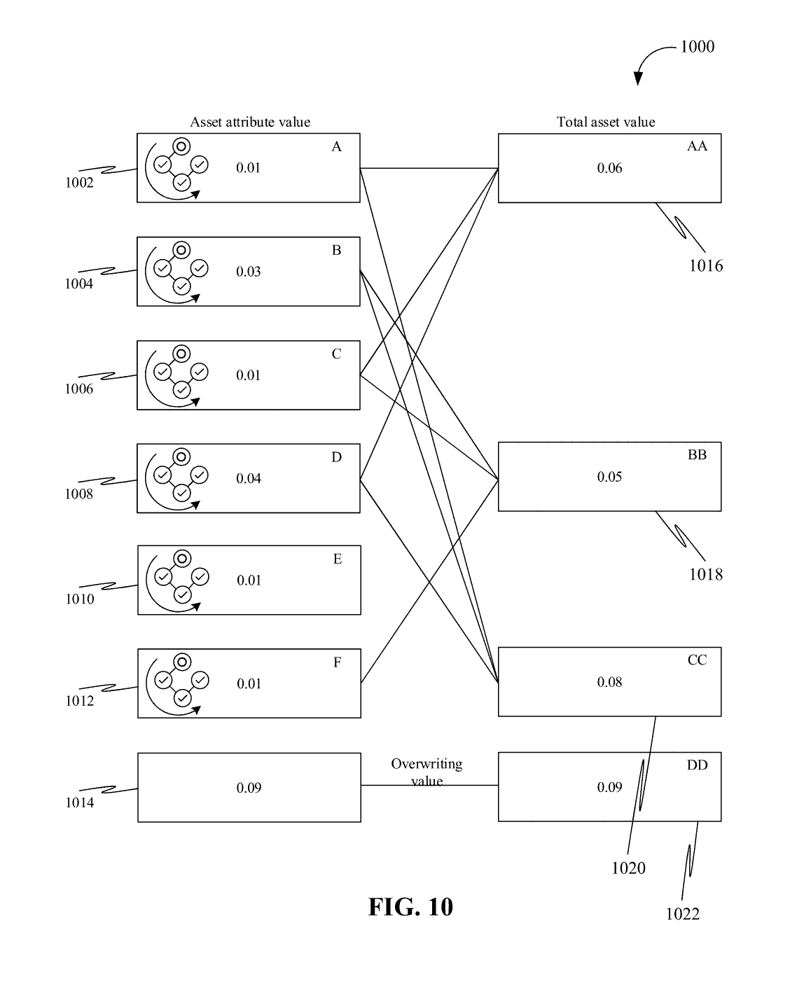

Further, the method 800 may include a step 804 of retrieving, using a storage device, a plurality of asset attribute values associated with the IOT device. The asset attribute may be a quality and/or a feature of an IOT device. The quality and/or the feature may include cost, impact on other IOT devices and/or network, history of problem/solution logs or reports, etc., corresponding to the IOT device. The asset attribute may be represented by an asset attribute value. The asset attribute value signifies the importance of asset attribute in the IOT device. The asset attribute value may be used to evaluate the total asset value of the corresponding IOT device. As shown in FIG. 10, the asset attribute “A” (such as cost) may have an asset attribute value 0.01. In an embodiment, the asset attribute value may be different for different IOT devices depending on the placement (i.e. location where the IOT device is installed) of IOT device in certain environment. For example, for an asset attribute such as temperature, the asset attribute value of an IOT device configured to monitor temperature in a chemical plant may be high compared to the asset attribute value of an IOT device installed in an office work space to monitor temperature.

In an embodiment, the IOT devices of a ride sharing company may include asset attribute such as, cost of the car, location tracking, car diagnostics, navigation, proximity detection, temperature monitoring, and so on. Accordingly, the asset attribute value of the asset attribute such as the car diagnostics may have a high value compared to the asset attribute value of an asset attribute such as the temperature monitoring.

Further, the method 800 may include a step 806 of generating, using a processing device, a total asset value from the plurality of asset attribute values. The total asset value of an IOT device may be generated by the summation of all the asset attribute values corresponding to the IOT device. The asset value associated with an IOT device may represent a significance of the IOT device. Accordingly, the high the asset value, the more significant is the IOT device in the environment.

Further, the method 800 may include a step 808 of retrieving, using the storage device, past behavioral pattern of the IOT device. The past behavioral pattern may include asset history of the IOT device. The asset history may be the asset attribute value or total asset value corresponding to the IOT device in the past (may be a week or a month).

Further, the method 800 may include a step 810 of determining, using the processing device, an overriding condition based on past behavioral pattern of the IOT device. The asset history may be taken into account while determining the overriding condition. For example, if an asset does something seemingly suspicious every Monday. The suspicious activity may be recorded. Further, the application of machine learning may be taken into account. Accordingly, this repetitive behavior every Monday may not be treated as a threat and the online platform may not generate any security alert.

Further, the method 800 may include a step 812 of overwriting, using the processing device, the total asset value based on the overriding condition. According to the overriding condition, if the total asset value exceeds a threshold value, the overwriting of asset value takes place. The threshold value for the asset corresponding an IOT device may depend on the past monitoring/behavioral data of the asset. Once, the total asset value exceeds the threshold value, the asset may be overwritten. The asset may be given a lower asset value and the asset may be reviewed for monitoring again. The online platform may detect the overwriting and generate a security alert and send it to the user.

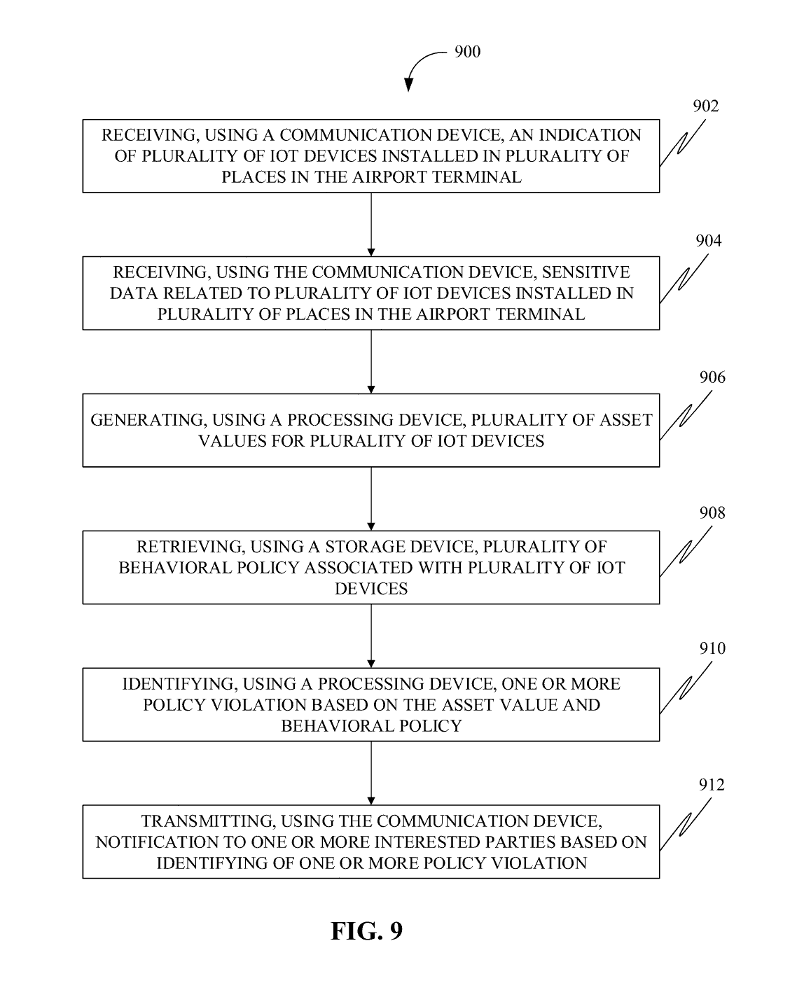

FIG. 9 illustrates a flowchart of the method 900 to facilitate the user to procure priority alerts from a plurality of TOT devices installed in an airport, in accordance with some embodiments. The method 900 may include a step 902 of receiving, using a communication device, an indication of plurality of TOT devices installed in plurality of places in the airport terminal. The indication of plurality of TOT devices may include the list of TOT devices installed in the Airport Terminal. The plurality of TOT devices may be installed in plurality of places, such as, but not limited to, check-in services, baggage services, security counters, passport verification booth, concessions, and so on. The asset value for an IOT device may vary depending on the place of installation. The plurality of IOT devices may also be installed in the runway of the Airport which may be used to monitor the activity of an Airplanes. For example, there may be sensors installed at the airport runway that may detect the presence of birds near the airport. The monitoring data from the detection may prevent bird strike during the take-off or landing of the airplane. The bird strike is a collision between an airborne animal (usually a bird or a bat) and a manmade vehicle such as an Airplane. In an embodiment, the same sensor may be used to detect intruders trying to enter the airport through the runway and identify drones flying around the airport. Such IOT devices used for security monitoring and prevention of mid-air collision may have a high asset value. The high asset value IOT devices may be filtered and security alerts regarding such TOT devices may be transmitted to the user.

Further, the method 900 may include a step 904 of receiving, using the communication device, sensitive data related to plurality of TOT devices installed in plurality of places in the airport terminal. The sensitive data may include the monitoring data, placement of TOT devices, effect of TOT device on another TOT device, and so on.

For example, the sensitive data may include the monitoring data of an TOT device installed in the check-in counter to determine the number of passengers in the queue. In another example, the sensitive data may include sensitive data corresponding to an TOT device installed in the baggage service to accurately examine the weight of the luggage. The sensitive data may be used to generate the asset value of the TOT device.

Further, the method 900 may include a step 906 of generating, using a processing device, plurality of asset values corresponding plurality of TOT devices. The asset value may be generated based on the asset attribute value of the plurality of TOT devices. The plurality of TOT devices may have plurality of asset attribute values. The plurality of asset attribute values may depend on quality and/or feature of the asset such as operation of the TOT device, cost, effect to other TOT devices, and so on. For example, the TOT sensor having security as an asset attribute allocated to detect the presence of harmful chemicals or any other hazardous substance in the passenger baggage may have a higher asset attribute value compared to the asset attribute such as taking picture of the baggage. Further, the method 900 may include a step 908 of retrieving, using a storage device, plurality of behavioral policy associated with plurality of TOT devices. Accordingly, the online platform may query internal and/or external databases in order to retrieve the behavioral policies associated with the plurality of IOT devices. The behavioral policies may represent policies and/or guidelines associated with the functioning, data-capturing, and notifying associated with the plurality of IOT devices.

Further, the method 900 may include a step 910 of identifying, using a processing device, one or more policy violation based on the asset value and behavioral policy. The policy violations may be identified based on comparison of monitoring-data associated with the selected set of IOT devices and the plurality of behavioral policies. Further, the online platform may identify whether a security risk associated with an IOT device is categorized as a low risk, medium risk, or a high risk. Further, the method may include a step of transmitting, using the communication device, a notification to one or more interested parties based on identifying the one or more policy violations.

Further, the method 900 may include a step 912 of transmitting, using the communication device, notification to one or more interested parties based on identifying of one or more policy violation. The notifications may be generated based on the policy violation. The online platform may perform filtering of notifications transmitted by the IOT devices and/or selective generation of notifications based on data transmitted by the IOT devices. Accordingly, the filtering of notifications associated with the IOT devices may prevent the IOT devices from sending multiple notifications to the user. In an ideal scenario, the online platform may filter notifications based upon asset value associated with the IOT devices. Therefore, the online platform may be configured to send notifications (e.g. high value alerts) corresponding to, for example, only high value assets. In an instance, the high value alerts may be called red alerts. Further, the high value alerts may either be based on a high value of an IOT device, high level of risk and/or a security breach, and/or a high value of the asset associated with the IOT device. For example, the IOT device used to monitor the power fluctuation in the terminal may have a high asset value and be considered red alert.

FIG. 10 illustrates a method 1000 to facilitate storing of asset values in an internal and/or external database, in accordance with some embodiments.

The asset attribute may be a quality and/or a feature of an IOT device. The quality and/or the feature may include cost, impact on other IOT devices and/or network, history of problem/solution logs or reports, etc., corresponding to the IOT device. The asset attribute may be represented by an asset attribute value. The asset attribute value signifies the importance of asset attribute in the IOT device. The asset attribute value may be used to evaluate the total asset value of the corresponding IOT device.

As shown in FIG. 10, the asset attribute “A” 1002 may have an asset attribute value 0.01. The asset attribute value determines the significance of the asset attribute. The asset attribute “A” 1002 may correspond to a quality and/or a feature affecting the asset value such as cost. The asset “AA” 1016 may comprise of the asset attributes, such as, “A” 1002, “C” 1006 and “D” 1008. Thus, the total asset value is the summation of asset attribute values of “A” 1002, “C” 1006 and “D” 1008 whose asset attribute values are 0.01, 0.01 and 0.04 respectively, thereby, making the total asset value of “AA” 1016 0.06. The asset “BB” 1018 may comprise of the asset attributes, such as, “B” 1004, “C” 1006 and “F” 1012. Thus, the total asset value is the summation of asset attribute values of “B” 1004, “C” 1006 and “F” 1012 whose asset attribute values are 0.03, 0.01 and 0.01 respectively, thereby, making the total asset value of “BB” 1018 0.05. The asset “CC” 1020 may comprise of the asset attributes, such as, “A” 1002, “B” 1004 and “D” 1008. Thus, the total asset value is the summation of asset attribute values of “A” 1002, “B” 1004 and “D” 1008 whose asset attribute values are 0.01, 0.03 and 0.04 respectively, thereby, making the total asset value of “BB” 1018 0.05.

Further, the overwriting condition may depend on the total asset value of an TOT device. According to the overwriting condition, if the total asset value exceeds a threshold value, the overwriting of asset value takes place and a security alert is generated. The threshold value for the asset corresponding an TOT device may depend on the past monitoring/behavioral data of the asset. For example, the overwriting condition for asset “DD” 1022 may be when the total asset value becomes equal or greater than 0.09, as shown in FIG. 10. The asset “DD” 1022 may comprise of the asset attribute having asset attribute value 0.09 1014. Thus, the total asset value of “DD” 1022 may also be 0.09. The total asset value being equal to the threshold value for the asset “DD” 1022 may initiate the overwriting condition. The online platform may overwrite the asset value of “DD” 1022. The online platform may also notify the user of the safety alert corresponding asset “DD” 1022.

Further, in one embodiment, the asset behavioral history may be taken into account while determining the overriding condition. For example, if an asset does something seemingly suspicious every Monday. The suspicious activity may be recorded. Further, the application of machine learning may be taken into account. Accordingly, this repetitive behavior every Monday may not be treated as a threat and the online platform may not generate any security alert.

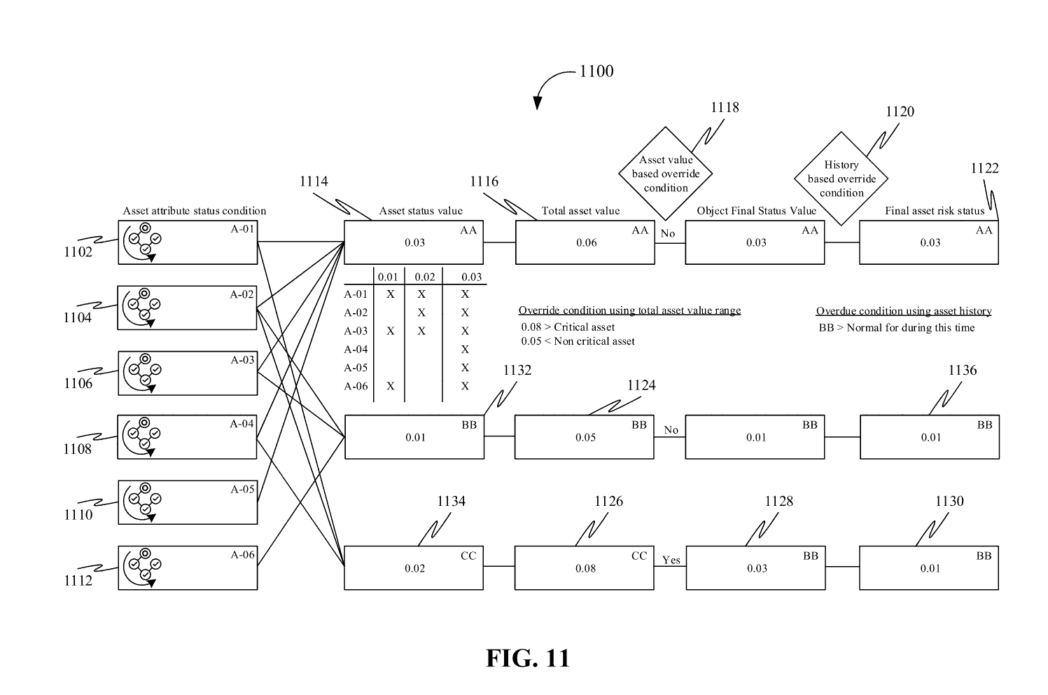

FIG. 11 illustrates a method 1100 to facilitate reporting of asset risk status in an asset database and dashboard, in accordance with some embodiments. The asset attribute may be a quality and/or a feature of an IOT device. The quality and/or the feature may include cost, impact on other IOT devices and/or network, history of problem/solution logs or reports, etc., corresponding to the IOT device. The asset attribute may be represented by an asset attribute value. The asset attribute value signifies the importance of asset attribute in the IOT device. The asset attribute value may be used to evaluate the total asset value of the corresponding IOT device.

As shown in FIG. 11, the asset “AA” 1114 may comprise of the asset attributes “A-01” 1102, “A-02” 1104, “A-03” 1106, “A-04” 1108 and “A-05” 1110. The total asset value 1116 may be the summation of asset attribute values of “A-01” 1102, “A-02” 1104, “A-03” 1106, “A-04” 1108 and “A-05” 1110. The asset “BB” 1124 may comprise of the asset attributes “A-02” 1104, “A-03” 1106 and “A-06” 1112. The total asset value 1116 may be the summation of asset attribute values of “A-02” 1104, “A-03” 1106 and “A-06” 1112. The asset “CC” 1126 may comprise of the asset attributes “A-01” 1102, “A-02” 1104 and “A-04” 1108. Thus, the total asset value is the summation of asset attribute values of “A-01” 1102, “A-02” 1104 and “A-04” 1108.

As shown in FIG. 11, an asset status value for “AA” 1114 indicates the risk associated with the particular asset. The asset having a high asset status values represent a high-risk status. The high-risk status may be represented by a specific color code “red”. The asset status value for “BB” is 0.01 and the asset status value for “CC” is 0.02 which may correspond to low and medium risk respectively.

The overwriting condition 1118 may depend on the total asset value of the IOT device. According to the overwriting condition, if the total asset value exceeds a threshold value, the overwriting of asset value takes place and a security alert is generated. The threshold value for the asset corresponding an IOT device may depend on the past monitoring/behavioral data of the asset. For example, the overwriting condition for the method 1100 may be the total asset value higher than or equal to 0.08. Accordingly, the total asset value of “CC” 1126 is 0.08 which may be equal to the threshold value and the overwriting condition may initiate. The online platform may generate a security alert. The overwriting may change the object final status value 1128 of “CC” which may correspond to the asset value status value of “BB”.

Further, the history based override condition 1120 may query an internal and/or external database for past monitoring data of the IOT device. For example, if an asset does something seemingly suspicious every Monday. The suspicious activity may be recorded. Further, the application of machine learning may be taken into account. Accordingly, this repetitive behavior on every Monday may not be treated as a threat anymore. The online platform may not generate any security alert. The final asset risk status may be based on the history based override condition 1120. The final asset risk status for “AA” 1122 may remain same, whereas, the final asset risk status for “CC” 1130 may change and correspond to the final asset risk status for “BB” 1136.

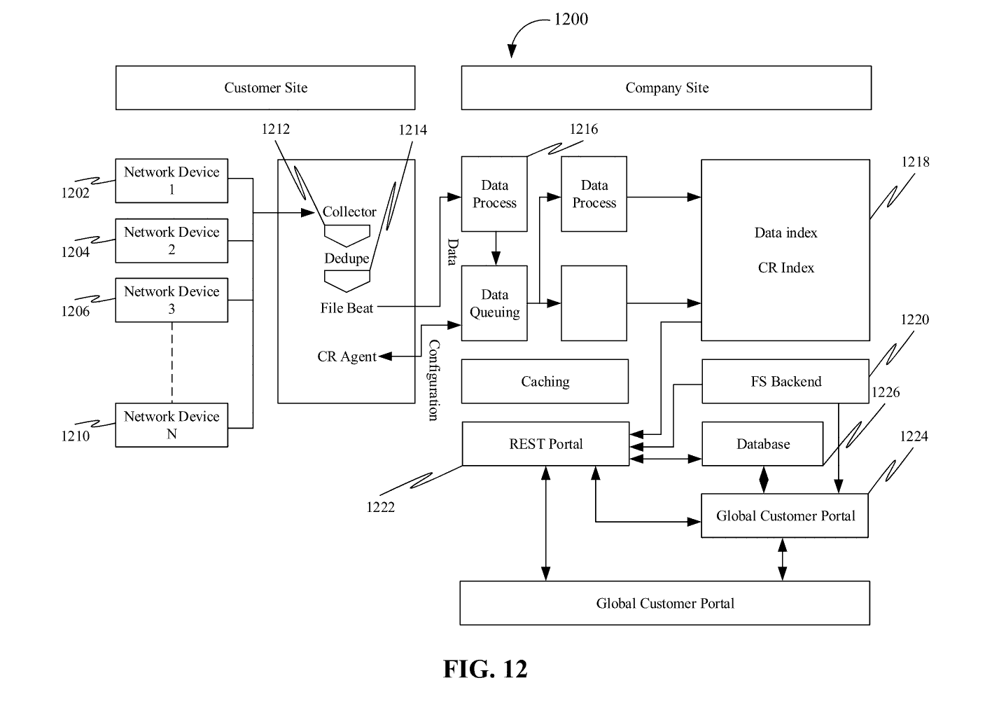

FIG. 12 illustrates a system 1200 to facilitate monitoring of IOT devices based on asset values, in accordance with some embodiments.

Accordingly, the system 1200 may include plurality of network devices. The system 1200 may receive the indication and/or the monitoring data from the plurality of IOT devices. The plurality of network devices may include “network device 1” 1202, “network device 2” 1204, “network device 3” 1206, “network device N” 1208, and so on.

Further, the system 1200 may include a collector 1212 and a dedupe 1214 to analyze the received data from the plurality of network devices. The collector 1212 may be visualized as an internal database. The collector may store the received monitoring data and may transfer it to dedupe 1214 for further processing. The dedupe 1214 may compare the monitored data with the past monitored data for the corresponding IOT device. The change may be detected and transmitted to the data process 1216.

The system may also contain components such as data indexing 1218, FS backend 1220, REST portal 1222, global customer portal 1224, and so on. The components may perform real-time operation to find the one or more violations corresponding to an IOT device. The one or more violations corresponding to the IOT device may be stored in the database 1226. The one or more violations corresponding to the IOT device may be transmitted to one or more interested parties.

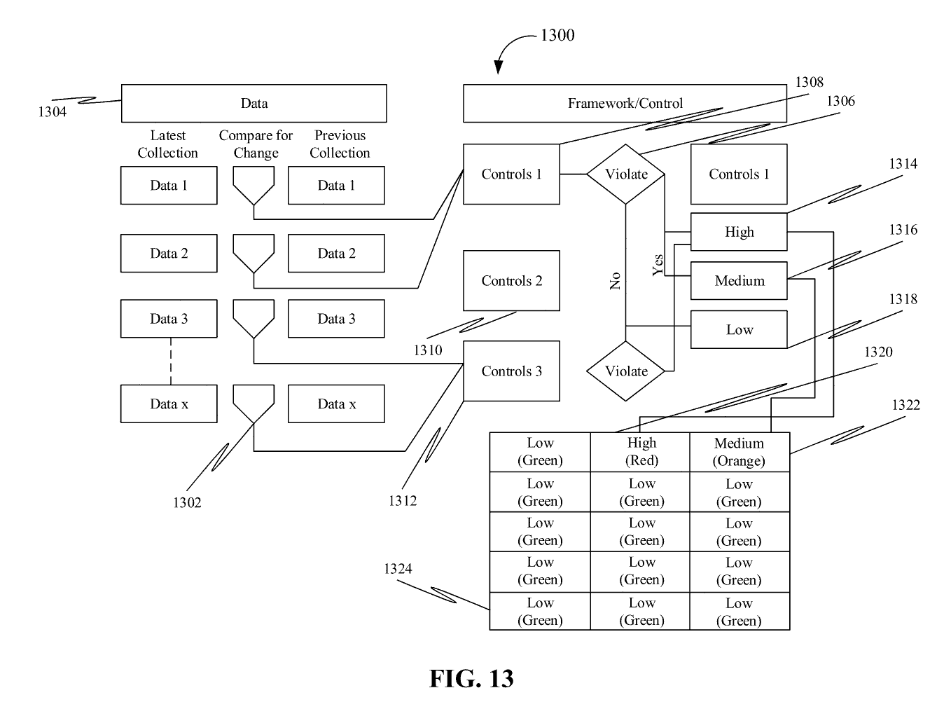

FIG. 13 is a flowchart of a method 1300 for depicting analysis performed by online platform based on a framework, in accordance with some embodiments.

According to some embodiments, the IOT device may compare 1302 the monitored-data 1304 with the behavioral policies stored in an internal and/or an external database. In an instance, the behavioral polices may include conditions corresponding to security violations 1306 associated with the IOT devices. Accordingly, based upon an evaluation of policy, the online platform may determine whether any policy violation 1306 and/or security breach has taken place.

According to an embodiment, a policy violation analysis may be performed by the IOT device. In an instance, the IOT device may fetch policies and/or control rules by communicating with an external database, which stores policies such as security violation policies. Further, the IOT device may perform a comparison 1302 between the policies and the monitored-data 1304. Accordingly, the online platform may alert the users who have been authorized by the online platform to receive alerts based on their role and/or the asset values associated with the IOT device.

According to some embodiments, the online platform may use control rules in order to determine a policy violation. In an instance, there may be a number of control rules which form the framework for determining a security breach and/or a policy violation.

First, the monitored-data 1304 may be gathered from the plurality of IOT devices installed at a particular location. Thereafter, the monitored-data 1304 may be evaluated against a number of control rules. In an instance, each control rule may include a security policy. Further, based upon evaluation, the online platform may determine whether the security breach and/or security violation has occurred.

Further, according to an embodiment, if the monitored data evaluated against the first control rule 1308 does not depict a security breach, then the monitored-data may be subsequently evaluated against the second 1310, third 1312, fourth control rule and so on. Further, if a policy volition 1306 (security breach) is detected, then the online platform may first identify level and/or risk associated with the policy violation 1306.

Further, in some embodiments, the level associated with the policy violation 1306 may be categorized as one of high 1314, medium 1316, and low 1318. In an instance, the level of the policy violation may also be associated with a color code. For example, if the level of a policy violation is high 1314, medium 1316, and low 1318, then the associated color may be red 1320, orange 1322 and green 1324 respectively.

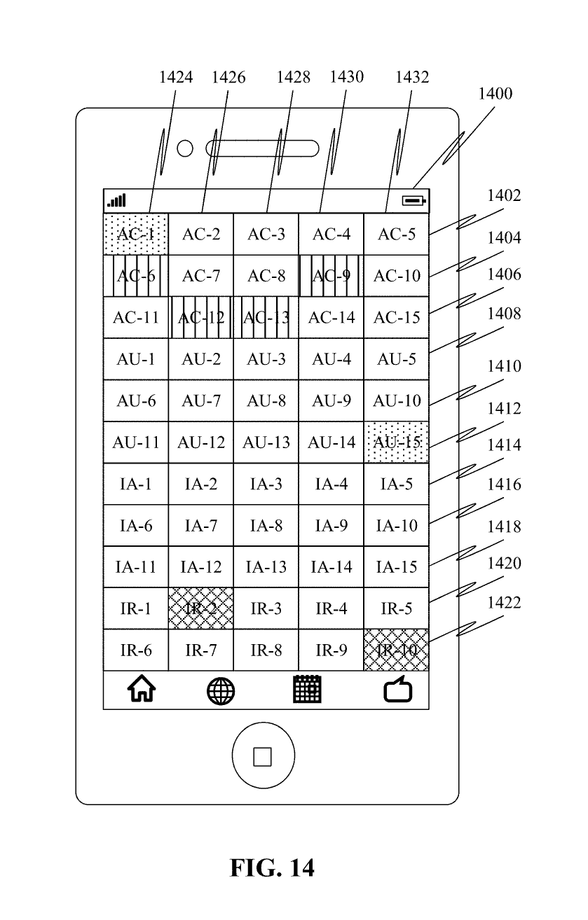

FIG. 14 is a user interface 1400 of a mobile application that provides visual feedback associated with the security status of a plurality of IOT devices, in accordance with some embodiments.

The user interface 1400 may include a grid comprising of rows 1402-1422 and columns 1424-1432. The rows 1402-1422 and columns 1424-1432 form multiple rectangular blocks. Each rectangular block corresponds to security status of an IOT device. Further, in each rectangular block, a code name associated with the IOT device may be displayed. Accordingly, the user may be able to identify the IOT device based upon the code name displayed in the rectangular block associated with the IOT device. For example, the rectangular block formed by the row 1402 and the column 1432 may represent security status of an IOT device designated with a code name “AC-1”.

The security status of an IOT device may be one of a high-risk, medium-risk, and low-risk. In a rectangular block, the security status of the corresponding IOT device may be represented using one or more patterns. As shown in FIG. 14, a dotted pattern may represent a high-risk security status, a vertical-line pattern may represent a medium-risk security status and a cross pattern may represent a low-risk security status. Accordingly, the rectangular blocks with the code names “AC-1” and “AU-15” correspond to IOT devices with high-risk security status. Further, the rectangular blocks with the code names “AC-6”, “AC-12”, “AC-9”, and “AC-13”, correspond to IOT devices with medium-risk security status. Accordingly, the rectangular blocks with the code names “IR-2” and “IR-10” correspond to IOT devices with low-risk security status. In an alternate embodiment, the security status of a IOT device may be represented using a color code. For example, red color may represent a high-risk security status, dark green may represent a medium-risk security status and a yellow may represent a low-risk security status.

Accordingly, the user interface 1400 allows the user to quickly view security status associated with the plurality of assets and/or IOT devices. Further, the user interface 1400 may allow the user to customize settings associated with viewing security status. In an instance, the user interface 1400 may allow the user to filter a specific set of IOT devices based on their individual asset value (or range of asset values), which is further based on various quality and/or features such as, cost, impact on other IOT devices and/or network, history of problem/solution logs or reports, etc. Accordingly, a frontend of the mobile application may only display alerts associated with the specific set of IOT devices and/or the assets filtered by the user. For example, a bank manager may apply a filter to only receive security status and/or alerts specific to IOT devices installed at the bank ATM and in the bank locker.

Further, in some embodiments, the mobile application may automatically determine asset value associated with each IOT device. Further, the mobile application may also receive an indication of the role (e.g. in an organizational hierarchy) of the user. Accordingly, the mobile application may generate a user interface 1400 and/or the frontend displaying security status of the IOT devices that have high asset value. Further, based upon the role of a user, the user interface 1400 may only depict security status associated with a pre-determined set of IOT devices. For example, if the user of the online platform is the floor supervisor of a factory, then the user interface 1400 of the mobile application may only display security status associated with IOT devices installed at the production floor and/or the machine shop.

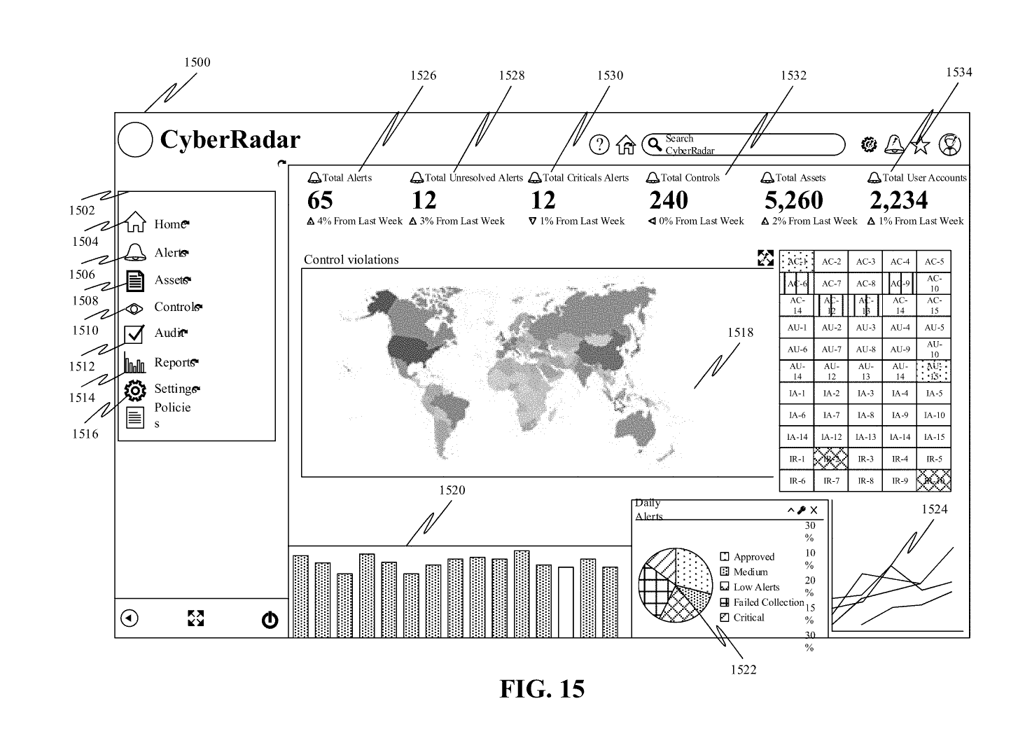

FIG. 15 illustrates a user interface 1500 that provides a high-level view of the security status associated with plurality of IOT devices deployed within an environment, in accordance with some embodiments.

The online platform may be accessed through a mobile and/or a web application that presents a user interface 1500 to the user that displays security status of the TOT devices installed at an area (e.g., at a government organization). Further, in an instance, the user interface may display security status of TOT devices based upon the corresponding asset values. Further, the online platform may depict criticality of risk associated with each IOT device using a color code pattern. For example, if risk associated with an IOT device is high, then the online platform may first categorize the risk under high alert category and also depict a visual feedback corresponding to the IOT device as red in color. Similarly, the IOT devices and/or assets which comes under low and medium risks may be shown with green and orange colors.

Further, in FIG. 15, the user interface 1500 may depict results of analysis associated with a plurality of IOT devices in the form of a bar graph 1520, pie-chart 1522, and line graphs 1524. In an instance, the results of analysis may be computed by comparing the monitoring-data with the corresponding security violation policies and associated plurality of asset values associated with the plurality of IOT devices.

The user interface 1500 may also denote total number of alerts 1526, number of weekly alerts, total resolved and unresolved alerts 1528, total critical (red marked) alerts 1530, total controls 1532, total assets 1534, and total user accounts 1536. Further, the user interface 1500 may also include a menu bar 1502, which contains options such as, Home 1502, Alert 1506, Assets 1508, Controls 1508, Audit 1512, Report 1514, Settings 1516, and Policies 1516, as shown in FIG. 15. As an example, the user interface 15 may allow the user to select the option called “Policies” in order to view the guidelines and/or policies associated with the plurality of IOT devices and/or the assets.

In FIG. 15, the user interface 1500 may depict a map 1518 based report. Accordingly, the map 1518 based report may highlight areas in the map 1518 where a security breach and/or a security violation has taken place.

Further, in some embodiments, the online platform may scan and collect all data associated with the plurality of IOT devices. Further, the online platform may use a Cyber Security Framework (i.e. NIST) and/or custom controls for risk evaluation. Accordingly, the online platform may display security related risks associated with the IOT devices in the form of a heat map 1518 that corresponds to a risk status and/or a security status.

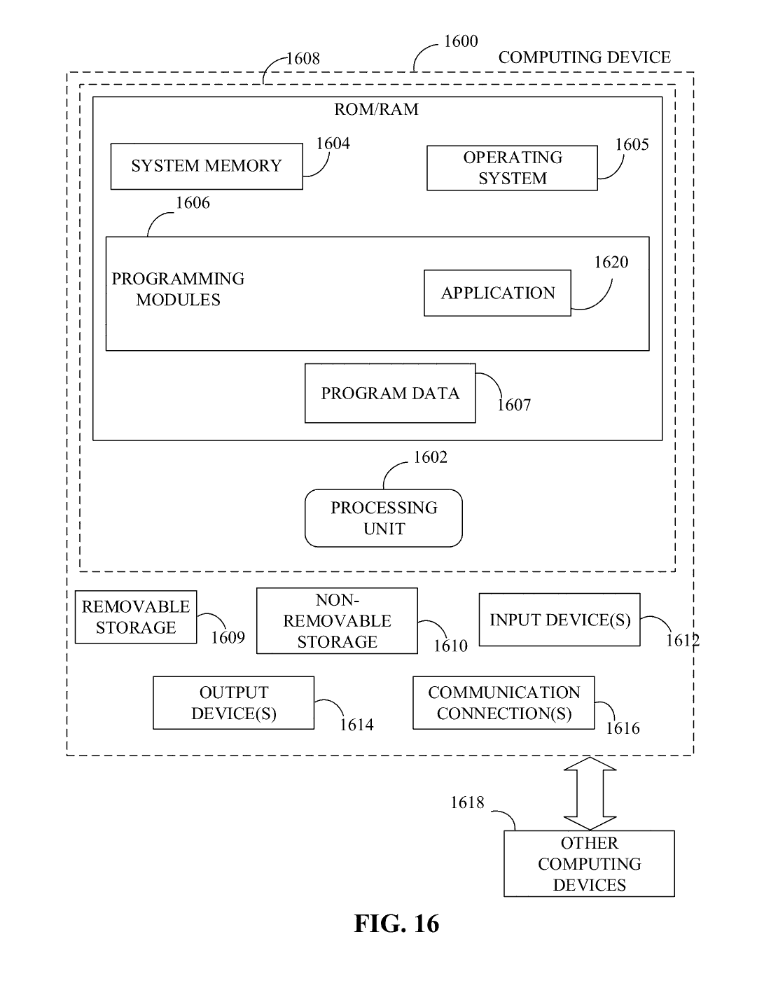

FIG. 16 is a block diagram of a system including computing device 1600 for implementing the methods disclosed herein, in accordance with some embodiments. Consistent with an embodiment of the disclosure, the aforementioned storage device and processing device may be implemented in a computing device, such as computing device 1600 of FIG. 16. Any suitable combination of hardware, software, or firmware may be used to implement the memory, storage and processing unit. For example, the storage device and the processing device may be implemented with computing device 1600 or any of other computing devices 1618, in combination with computing device 1600. The aforementioned system, device, and processors are examples and other systems, devices, and processors may comprise the aforementioned storage device and processing device, consistent with embodiments of the disclosure.

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include security analysis module, access control module and heat map generation module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and nonvolatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618 over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620 such as a media player) may perform processes including, for example, one or more stages of methods, algorithms, systems, applications, servers, databases as described above. The aforementioned process is an example, and processing unit 1602 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, random access memory (RAM), read-only memory (ROM), erasable programmable read-only memory (EPROM or Flash memory), optical fiber and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in computer memory.

Embodiments of the present disclosure, for example, are described above with reference to block diagrams and/or operational illustrations of methods, systems and computer program products according to embodiments of the disclosure. The functions/acts noted in the blocks may occur out of the order as shown in any flowchart. For example, two blocks shown in succession may in fact be executed substantially concurrently or the blocks may sometimes be executed in reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

We claim:

1. A method for monitoring of IOT devices based on asset values, the method comprising:
receiving, using a communication device, monitoring data from a plurality of IOT devices;
retrieving, using a storage device, a plurality of asset values associated with the plurality of IOT devices;
retrieving, using the storage device, at least one behavioral policy associated with the plurality of IOT devices;
comparing, using a processing device, the monitoring data with the at least one behavioral policy;
identifying, using the processing device, at least one policy violation based on the comparing and the plurality of asset values; and
transmitting, using the communication device, at least one notification to at least one user device, wherein the at least one notification is based on identifying the at least one policy violation.

2. The method of claim 1, wherein the at least one notification comprises a heat map depicting the at least one policy violation, wherein the method further comprises generating, using the processing device, the heat map.

3. The method of claim 1, wherein an IOT device comprises at least one sensor configured to detect at least one variable associated with an environment and a wireless transmitter communicatively coupled to the at least one sensor, wherein the wireless transmitter is configured for wirelessly transmitting monitoring data from the at least one sensor to a server computer.

4. The method of claim 1, wherein an asset value of the plurality of asset values associated with an IOT device of the plurality of IOT devices is based on a significance of at least one of the IOT device and an asset associated with the IOT device.

5. The method of claim 1 further comprising:
retrieving, using the storage device, a plurality of asset attribute values associated with the plurality of assets;
determining, using the processing device, the plurality of asset values based on the plurality of asset attribute values; and
storing, using the storage device, the plurality of asset values.

6. The method of claim 1, wherein the at least one behavioral policy comprises a plurality of behavioral policies, wherein a plurality of behavioral policies is associated with a plurality of risk levels.

7. The method of claim 1, wherein an TOT device of the plurality of TOT devices comprises a first TOT device and a second TOT device, wherein the monitoring data comprises security status data associated with the first TOT device and operational data associated with the first TOT device, wherein the first TOT device is configured to generate the security status data, wherein the second TOT device is configured to generate the operational data associated with the first TOT device.

8. The method of claim 1 further comprising receiving, using the communication device, a role indicator from a user device of the at least one user device, wherein the role indicator represents a role of a user associated with the user device, wherein the identifying of the at least one policy violation is further based on the role.

9. The method of claim 1 further comprising:
storing, using the storage device, the monitoring data in association with a plurality of indicators associated with the plurality of TOT devices, wherein the monitoring data corresponds to a first time period;
analyzing, using the processing device, the monitoring data corresponding to the first time period;
updating, using the processing device, the at least one behavioral policy based on the analyzing to obtain at least one updated behavioral policy; and
storing, using the storage device, the at least one updated behavioral policy, wherein the comparing comprises comparing the monitoring data corresponding to a second time period with the at least one updated behavioral policy, wherein the second time period is later than the first time period.

10. The method of claim 1 further comprising:
receiving, using the communication device, an asset value indicator from a user device of the at least one user device; and
identifying, using the processing device, the plurality of TOT devices based on the asset value indicator.

11. A system for monitoring of TOT devices based on asset values, the system comprising:
a communication device configured for:
receiving monitoring data from a plurality of TOT devices; and
transmitting at least one notification to at least one user device, wherein the at least one notification is based on identifying at least one policy violation.
a processing device configured for:
comparing the monitoring data with at least one behavioral policy;
identifying the at least one policy violation based on the comparing and the plurality of asset values; and
a storage device configured for:
retrieving a plurality of asset values associated with the plurality of TOT devices; and
retrieving the at least one behavioral policy associated with the plurality of TOT devices.

12. The system of claim 11, wherein the at least one notification comprises a heat map depicting the at least one policy violation, wherein the processing device is further configured for generating the heat map.

13. The system of claim 11, wherein an IOT device comprises at least one sensor configured to detect at least one variable associated with an environment and a wireless transmitter communicatively coupled to the at least one sensor, wherein the wireless transmitter is configured for wirelessly transmitting monitoring data from the at least one sensor to a server computer.

14. The system of claim 11, wherein an asset value of the plurality of asset values associated with an IOT device of the plurality of IOT devices is based on a significance of at least one of the IOT device and an asset associated with the IOT device.

15. The system of claim 11, wherein the storage device is further configured for:
retrieving a plurality of asset attribute values associated with the plurality of assets; and
storing the plurality of asset values, wherein the processing device is further configured for determining the plurality of asset values based on the plurality of asset attribute values.

16. The system of claim 11, wherein the at least one behavioral policy comprises a plurality of behavioral policies, wherein a plurality of behavioral policies is associated with a plurality of risk levels.

17. The system of claim 11, wherein an IOT device of the plurality of IOT devices comprises a first IOT device and a second IOT device, wherein the monitoring data comprises security status data associated with the first IOT device and operational data associated with the first IOT device, wherein the first IOT device is configured to generate the security status data, wherein the second TOT device is configured to generate the operational data associated with the first TOT device.

18. The system of claim 11, wherein the communication device is further configured for receiving a role indicator from a user device of the at least one user device, wherein the role indicator represents a role of a user associated with the user device, wherein the identifying of the at least one policy violation is further based on the role.

19. The system of claim 11, wherein the storage device is further configured for:
storing the monitoring data in association with a plurality of indicators associated with the plurality of TOT devices, wherein the monitoring data corresponds to a first time period;
storing at least one updated behavioral policy, wherein the comparing comprises comparing the monitoring data corresponding to a second time period with at least one updated behavioral policy, wherein the second time period is later than the first time period, wherein the processing device is further configured for:
analyzing the monitoring data corresponding to the first time period; and
updating the at least one behavioral policy based on the analyzing to obtain the at least one updated behavioral policy.

20. The system of claim 11, wherein the communication device is further configured for receiving an asset value indicator from a user device of the at least one user device, wherein the processing device is further configured for identifying the plurality of TOT devices based on the asset value indicator.
